(19) United States
(12) Patent Application Publication
(10) Pub. No.: US 2021/0397938 A1
(43) Pub. Date: Dec. 23, 2021

(54) DETECTION DEVICE AND DETECTION PROGRAM

(71) Applicant: NIPPON TELEGRAPH AND TELEPHONE CORPORATION, Tokyo (JP)

(72) Inventors: Shotaro TORA, Musashino-shi, Tokyo (JP); Masashi TOYAMA, Musashino-shi, Tokyo (JP); Machiko TOYODA, Musashino-shi, Tokyo (JP)

(73) Assignee: NIPPON TELEGRAPH AND TELEPHONE CORPORATION, Tokyo (JP)

(21) Appl. No.: 17/421,378

(22) PCT Filed: Feb. 13, 2020
(86) PCT No.: PCT/JP2020/005474

§ 371 Date: Jul. 8, 2021

(30) Foreign Application Priority Data
Feb. 28, 2019 (JP) 2019-037021

(51) Int. Cl. G06N 3/063; G06N 3/08; G06F 16/23

(52) U.S. Cl. CPC G06N 3/063; G06F 16/2365; G06N 3/08

(57) ABSTRACT

A preprocessing unit (131) processes data for training and detection object data. Also, a generation unit (132) generates a model in a normal state by deep learning, on the basis of the data for training that is processed by the preprocessing unit (131) . Also, a detection unit (133) calculates a degree of anomaly on the basis of output data obtained by inputting the detection object data and that is processed by the preprocessing unit (131) into the model, and detecting an anomaly in the detection object data on the basis of the degree of anomaly.

### TECHNICAL FIELD

The present invention relates to a detection device and a detection program.

### BACKGROUND ART

There conventionally is known anomaly detection technology using autoencoders (AE: autoencoder) and recurrent neutral networks (RNN: Recurrent neural network, LSTM: Long short-term memory, GRU: Gated recurrent unit) that are models using deep learning (Deep Learning). For example, in conventional technology using an autoencoder, a model is first generated by learning normal data. Then, the greater the reconstruction error between detection object data and output data obtained by inputting the data into a model is, the greater the degree of anomaly is judged to be.

### CITATION LIST

### Non Patent Literature

[NPL 1] Yasuhiro Ikeda, Keisuke Ishibashi, Yusuke Nakano, Keishiro Watanabe, Ryoichi Kawahara, “Retraining anomaly detection model using Autoencoder”, IEICE Technical Report IN2017-84

### SUMMARY OF THE INVENTION

### Technical Problem

However, there is a problem in the conventional technology in that when performing anomaly detection using deep learning, there are cases in which detection precision deteriorates. For example, there are cases in the conventional technology in which appropriate preprocessing is not performed on data for training for anomaly detection or detection object data. Also, in the conventional technology, model generation is dependent on random numbers, and accordingly it is difficult to confirm whether a model is unique with respect to training data. Also, there are cases in the conventional technology where the possibility that the training data contains anomalies is not taken into consideration. In any of these cases, it is conceivable that detection precision of anomaly detection will deteriorate. Note that deterioration in detection precision as used here indicates a lower detection rate in detecting data with anomalies as being abnormal, and an increase in erroneous detection rate where normal data is detected as being abnormal.

### Means for Solving the Problem

In order to solve the above-described problem, and achieve the object, a detection device includes a preprocessing unit that processes data for training and detection object data, a generation unit that generates a model by deep learning, on the basis of data for training that is processed by the preprocessing unit, and a detection unit that calculates a degree of anomaly on the basis of output data obtained by inputting the detection object data that is processed by the preprocessing unit into the model, and detecting an anomaly in the detection object data on the basis of the degree of anomaly.

### Effects of the Invention

According to the present invention, preprocessing and selection of training data in a case of performing anomaly detection using deep learning, and model selection can be appropriately performed, and detection precision can be improved.

### BRIEF DESCRIPTION OF DRAWINGS

FIG. 1 is a diagram illustrating an example of a configuration of a detection device according to a first embodiment.

FIG. 2 is a diagram for explaining about an autoencoder.

FIG. 3 is a diagram for explaining about learning.

FIG. 4 is a diagram for explaining about anomaly detection.

FIG. 5 is a diagram for explaining about the degree of anomaly for each feature value.

FIG. 6 is a diagram for explaining about identifying feature values with little change.

FIG. 7 is a diagram illustrating examples of increasing data and decreasing data.

FIG. 8 is a diagram illustrating examples of data obtained by converting increasing data and decreasing data.

FIG. 9 is a diagram illustrating an example of a case of models stabilizing.

FIG. 10 is a diagram illustrating an example of a case of models not stabilizing.

FIG. 11 is a diagram illustrating an example of results of fixed-period learning.

FIG. 12 is a diagram illustrating an example of results of sliding learning.

FIG. 13 is a diagram illustrating examples of the degree of anomaly for each normalization technique.

FIG. 14 is a flowchart illustrating the flow of learning processing in the detection device according to the first embodiment.

FIG. 15 is a flowchart illustrating the flow of detection processing in the detection device according to the first embodiment.

FIG. 16 is a diagram illustrating an example of the degree of anomaly

of text logs.

FIG. 17 is a diagram illustrating an example of relation between the degree of anomaly of text logs and failure information.

FIG. 18 is a diagram illustrating an example of text logs at the time of failure occurring, and the degree of anomaly of each feature value.

FIG. 19 is a diagram illustrating an example of text logs at the time of the degree of anomaly rising, and the degree of anomaly of each feature value.

FIG. 20 is a diagram illustrating an example of data distribution of text log IDs at clock times before and after the degree of anomaly rising.

FIG. 21 is a diagram illustrating an example of the degree of anomaly of numerical value logs.

FIG. 22 is a diagram illustrating an example of relation between the degree of anomaly of numerical value logs and failure information.

FIG. 23 is a diagram illustrating an example of numerical value logs at the time of failure occurring, and the degree of anomaly of each feature value.

FIG. 24 is a diagram illustrating an example of input data and output data for each feature value of numerical value logs.

FIG. 25 is a diagram illustrating an example of a computer that executes a detection program.

### DESCRIPTION OF EMBODIMENTS

Embodiments of a detection device and a detection program according to the present application will be described in detail below with reference to the figures. Note that the present invention is not limited by the embodiments described below.

### Configuration of First Embodiment

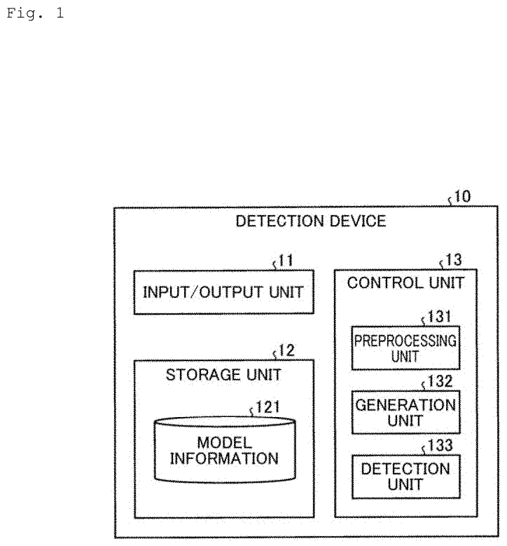

First, the configuration of a detection device according to a first embodiment will be described with reference to FIG. 1. FIG. 1 is a diagram illustrating an example of a configuration of the detection device according to the first embodiment. The detection device 10 has an input/output unit 11, a storage unit 12, and a control unit 13, as illustrated in FIG. 1.

The input/output unit 11 is an interface for performing input and output of data. For example, the input/output unit 11 may be a NIC (Network Interface Card) for performing data communication with other devices over a network.

The storage unit 12 is a storage device such as an HDD (Hard Disk Drive), an SSD(Solid State Drive), an optical disc, or the like. Note that the storage unit 12 may be semiconductor memory in which data is rewritable, such as RAM (Random Access Memory), flash memory, NVSRAM (Non Volatile Static Random Access Memory), and so forth. The storage unit 12 stores an OS (Operating System) and various types of programs that are executed in the detection device 10. The storage unit 12 further stores various types of information used in executing the programs. The storage unit 12 also stores model information 121.

The model information 121 is information for constructing a generation model. The generation model in the present embodiment is an autoencoder. Also, the autoencoder is configured of an encoder and a decoder. The encoder and the decoder are each a neural network. Accordingly, the model information 121 includes the number of layers of the encoder and of the decoder, the number of dimensions of each layer, the weighting among nodes, the bias of each layer, and so forth, for example. Also, of the information included in the model information 121, parameters that are updated by learning, such as weighting, bias, and so forth, may be referred to as model parameters in the following description. Also, the generation model may be referred to simply as model.

The control unit 13 controls the overall detection device 10. The control unit 13 is, for example, an electronic circuit such as a CPU (Central Processing Unit), an MPU (Micro Processing Unit), or the like, or an integrated circuit such as an ASIC (Application Specific Integrated Circuit), an FPGA (Field Programmable Gate Array), or the like. The control unit 13 also has internal memory for storing programs and control data defining various types of processing procedures, and each processing is executed using the internal memory. The control unit 13 also functions as various types of processing units by various types of programs running. For example, the control unit 13 has a preprocessing unit 131, a generation unit 132, a detection unit 133, and an updating unit 134.

The preprocessing unit 131 processes data for training and detection object data. Also, the generation unit 132 generates a model by deep learning, on the basis of data for training that is processed by the preprocessing unit 131. Also, the detection unit 133 calculates a degree of anomaly on the basis of output data obtained by inputting the detection object data and that is processed by the preprocessing unit 131, into a model, and detects an anomaly in the detection object data on the basis of the degree of anomaly. Note that the generation unit 132 uses an autoencoder for deep learning in the embodiment. Also, in the following description, data for training and detection object data will be referred to as training data and test data, respectively.

Thus, the detection device 10 can perform learning processing and detection processing by the processing of the units of the control unit 13. The generation unit 132 also stores information of generated models in the storage unit 12 as model information 121. Also, the generation unit 132 updates the model information 121. The detection unit 133 constructs an autoencoder on the basis of the model information 121 stored in the storage unit 12, and performs anomaly detection.

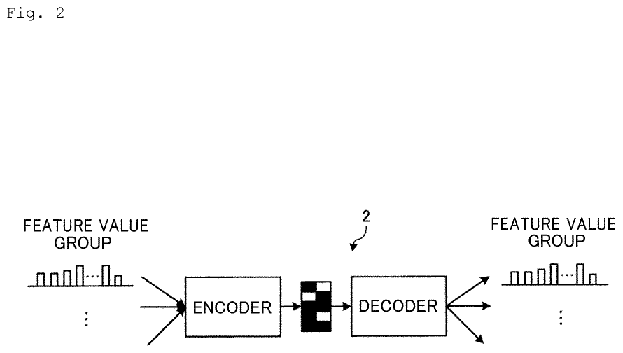

Now, the autoencoder according to the embodiment will be described with reference to FIG. 2. FIG. 2 is a diagram for explaining about an autoencoder. An AE network 2 configuring the autoencoder has an encoder an and a decoder, as illustrated in FIG. 2. One or more feature values included in data are input to the AE network 2, for example. The encoder converts an input feature value group into a compressed representation. The decoder further generates a feature value group from the compressed representation. At this time, the decoder generates data having the same structure as the input data.

Generation of data in this way by the autoencoder is referred to as reconstruction. Also, the data that has been reconstructed is referred to as reconstructed data. Also, the error between the input data and the reconstructed data is referred to as reconstruction error.

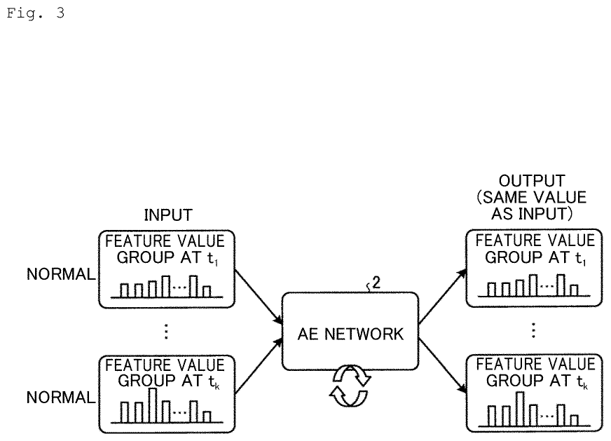

Learning at the autoencoder will be described with reference to FIG. 3. FIG. 3 is a diagram for explaining about learning. When learning, the detection device 10 inputs normal data at each clock time to the AE network 2, as illustrated in FIG. 3. The detection device 10 then optimizes the parameters of the autoencoder so that the reconstruction error is small. Accordingly, when sufficient learning is performed, the input data and the reconstructed data are the same values.

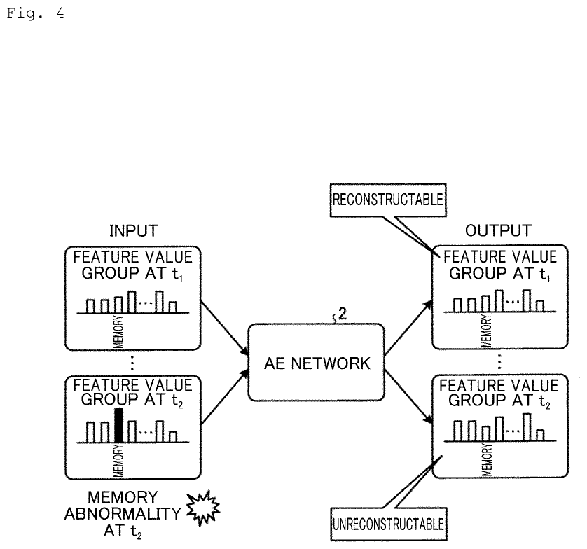

Anomaly detection by the autoencoder will be described with reference to FIG. 4. FIG. 4 is a diagram for explaining about anomaly detection. The detection device 10 inputs data regarding which normality/abnormality is unknown to the AE network 2, as illustrated in FIG. 4.

Now, the data at clock time t₁ is normal here. At this time, the reconstruction error regarding the data at clock time t₁ is sufficiently small, and the detection device 10 judges that the data at clock time t₁ is reconstructable, i.e., is normal.

Conversely, the data at clock time t₂ is abnormal here. At this time, the reconstruction error regarding the data at clock time t₂ is great, and the detection device 10 judges that the data at clock time t₁ is unreconstructable, i.e., is abnormal. Note that the detection device 10 may determine the magnitude of reconstruction error by a threshold value.

For example, the detection device 10 can perform learning and anomaly detection using data having a plurality of feature values. At this time, the detection device 10 can calculate not only the degree of anomaly of each data, but also the degree of anomaly of each feature value.

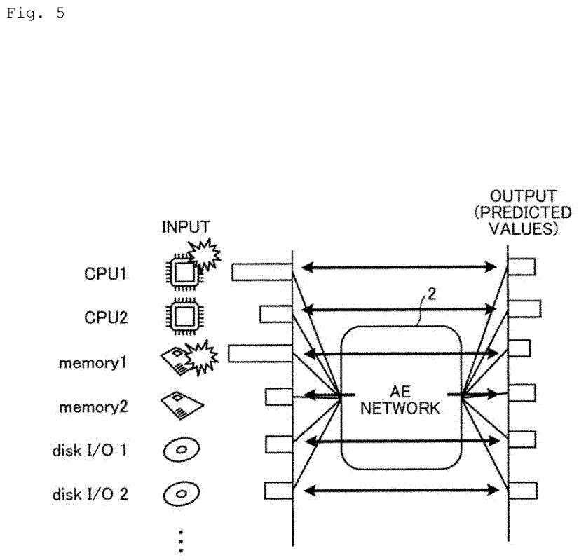

The degree of anomaly for each feature value will be described with reference to FIG. 5. FIG. 5 is a diagram for explaining about the degree of anomaly for each feature value. In the example in FIG. 5, the feature values are the CPU usage rate at each clock time, memory usage rate, disk I/O speed, and so forth, in a computer. For example, comparing the feature values of input data and the feature values of reconstructed data shows that there is a great difference in the values of CPU1 and memory1. In this case, it can be estimated that there is a possibility of an anomaly occurring of which the CPU1 and memory1 are the cause.

Also, the model of the autoencoder can be made to be compact, without being dependent on the size of the training data. Also, if the model has already been generated, detection is performed by matrix computation, and accordingly processing can be performed at high speeds.

On the basis of logs output from a device that is an object of detection, the detection device 10 according to the embodiment can detect anomalies of this device. Logs may be, for example, sensor data collected by sensors. The device that is the object of detection may be an information processing device such as a server or the like, or may be an IoT device, for example. Examples of the device that is the object of detection are onboard equipment installed in automobiles, wearable measurement equipment for medical purposes, inspection devices used on manufacturing lines, routers on the perimeter of a network, and so forth. Also, types of logs include numerical values and text. In a case of an information processing device, for example, numerical value logs are measurement values collected from a device such as a CPU or memory or the like, and text logs are message logs such as in syslog or MIB.

Now there are cases where simply performing learning with the autoencoder and performing anomaly detection using a trained model alone does not yield sufficient detection precision. For example, in a case where appropriate preprocessing is not performed for each piece of data, or in a case where model selection is incorrect when learning has been performed a plurality of times, or in a case where the possibility that the training data might contain an anomaly is not taken into consideration, it is conceivable that the detection precision may deteriorate. Accordingly, the detection device 10 executes at least one of the processing described below, whereby detection precision can be improved.

(1. Identification of Feature Value with Little Change)

In a case where a feature value, which has little change in the training data, changes even slightly in the detection object data, there are cases where this greatly affects the detection results. In this case, the degree of anomaly regarding data that originally is not abnormal becomes excessively great, and erroneous detection readily occurs.

Accordingly, the preprocessing unit 131 identifies feature values in the data for training that is time-series data of feature values of which the degree in magnitude of change over time is no more than a predetermined value. Also, the detection unit 133 detects anomalies on the basis of at least one of feature values identified by the preprocessing unit 131 and feature values other than feature values identified by the preprocessing unit 131, out of the feature values of the detection object data.

That is to say, the detection unit 133 can perform detection using only feature values with large change in the training data, out of the feature values in the test data. Thus, the detection device 10 can suppress the effects of the degree of anomaly in a case of a feature value, which has little change in the training data, changing even slightly in the detection object data, and can suppress erroneous detection of data that is not abnormal.

Conversely, the detection unit 133 can perform detection using only feature values with little change in the training data, out of the feature values in the test data. In this case, the detection device 10 increases the scale of degree of anomaly in detection. Thus, the detection device 10 can detect cases only in which change is great in the detection object data as being abnormal.

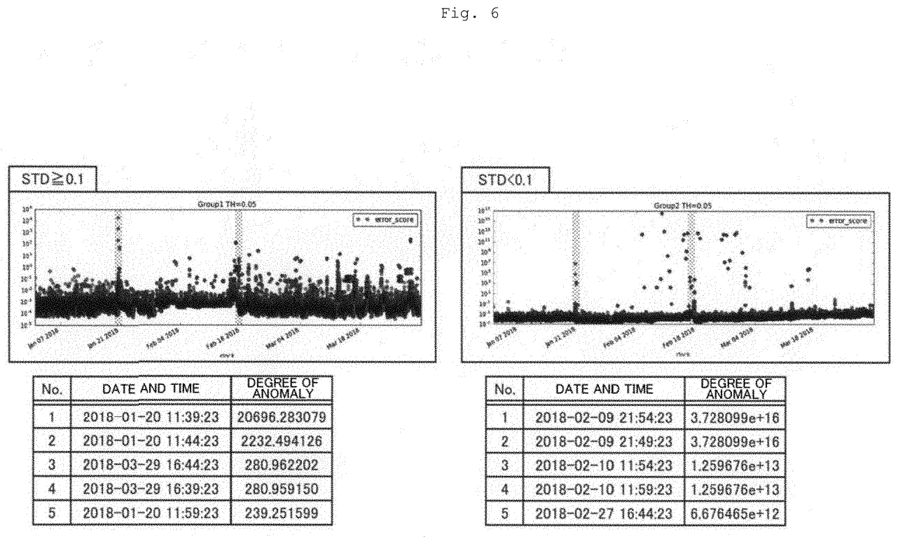

FIG. 6 is a diagram for explaining about identifying feature values with little change. The tables at the upper portion of FIG. 6 show, when calculating standard deviation (STD) of training data of feature values, and setting threshold values, the number of feature values that come under the threshold values. For example, in a case in which a threshold value is set to 0.1, the number of feature values where STD 0.1 (number of performance values of Group1) is 132. Also, at this time, the number of feature values where STD<0.1 (number of performance values of Group2) is 48.

In the example in FIG. 6, the threshold value of standard deviation of feature values is set to 0.1. At this time, the preprocessing unit 131 identifies feature values of which the standard deviation is smaller than 0.1 out of among the training data. In a case where the detection unit 133 performed detection using the feature values identified from the test data (STD<0.1), the degree of anomaly was around 6.9×10¹² to 3.7×10¹⁶. Conversely, in a case where the detection unit 133 performed detection excluding the feature values identified from the test data (STD≥0.1), the degree of anomaly was extremely small as compared to the case of STD<0.1, and was around 20,000 maximum.

(2. Conversion of Increasing or Decreasing Data)

There is data that increases or decreases, such as data output from a server system. The range of values, which feature values of such data can assume, differ between the training data and the test data in some cases, which is a cause of erroneous detection. For example, in a cases of a cumulative value, there are cases where the degree of change and so forth of value is more meaningful than the cumulative value itself.

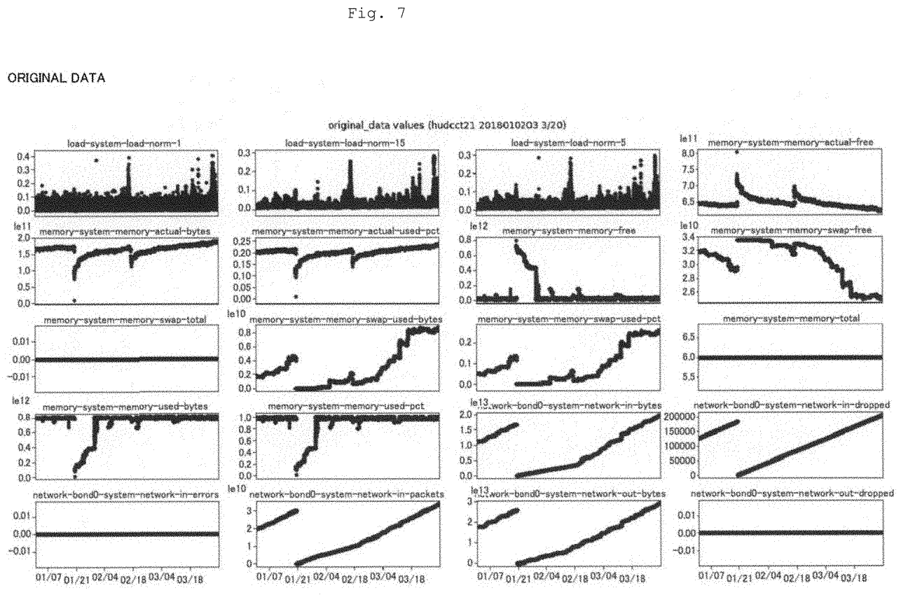

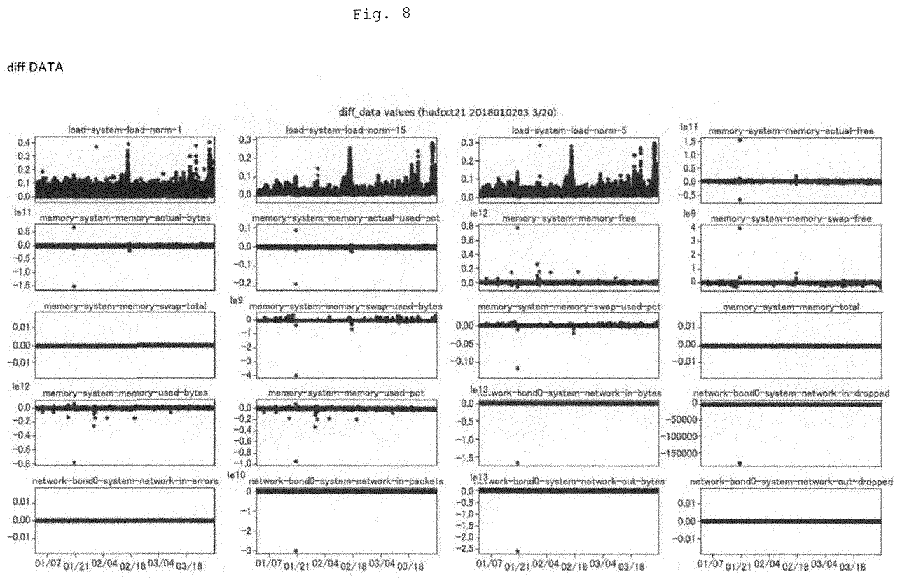

Accordingly, the preprocessing unit 131 converts part or all of the data for training and the detection object data into difference or ratio of this data among predetermined clock times. The preprocessing unit 131 may, for example, obtain difference in values of data among clock times, or may divide the value of data at a certain clock time by the value of data at the immediately-preceding clock time. Accordingly, the detection device 10 can suppress the effects of difference in the range that the training data and the test data can assume, suppress occurrence of erroneous detection, and further facilitate detection of anomalies in feature values in test data that exhibit different changes as compared to when training. FIG. 7 is a diagram illustrating examples of increasing data and decreasing data. Also, FIG. 8 is a diagram illustrating examples of data obtained by converting increasing data and decreasing data.

(3. Selection of Optimal Model)

When training a model, there are cases in which initial values and so forth of model parameters are randomly decided. For example, when training a model using a neural network including an autoencoder, there are cases in which initial values such as weighting between nodes and so forth are randomly decided. Also, there are cases in which nodes to be the object of dropout at the time of backpropagation are randomly decided.

In such a case, even of the number of layers, and the number of dimensions (number of nodes) per layer are the same, the model generated at the end is not necessarily the same every time. Accordingly, performing training trials a plurality of times while changing the pattern of randomness will result in a plurality of models being generated. Changing the pattern of randomness is generating random numbers used as initial values again, for example. In such cases, the degree of anomaly calculated by each model may differ, which causes erroneous detection depending on the model used for anomaly detection.

Accordingly, the generation unit 132 performs learning for each of a plurality of patterns. That is to say, the generation unit 132 performs learning of the data for training a plurality of times. The detection unit 133 detects anomalies using a model selected out of models generated by the generation unit 132 in accordance with the strength of relation with each other. The generation unit 132 calculates, as the strength of relation, a correlation coefficient among degrees of anomaly calculated from the reconstructed data when the same data is input.

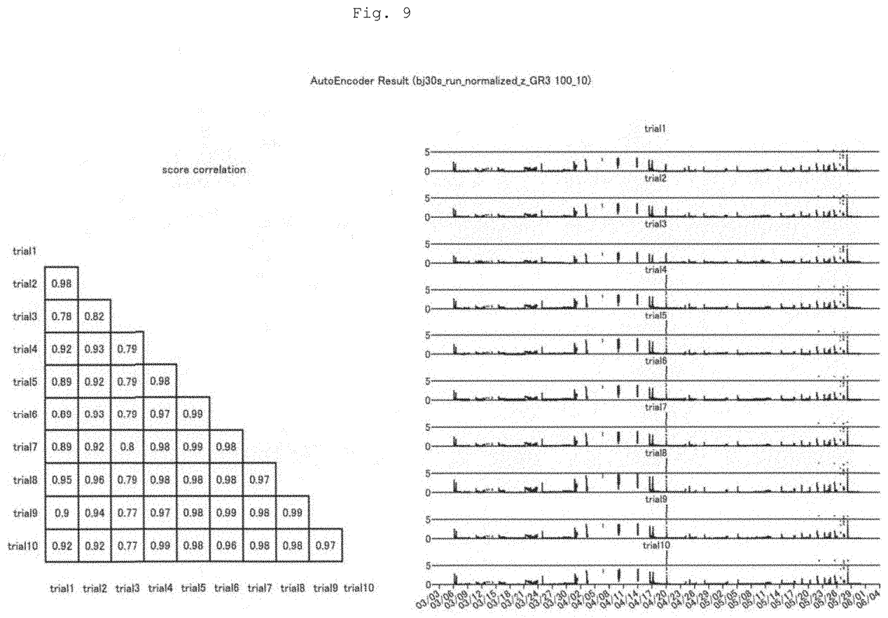

FIG. 9 is a diagram illustrating an example of degree of anomaly in a case of models stabilizing. The numerical values in the rectangles are correlation coefficients among degrees of anomaly among the models. For example, the correlation coefficient between trial3 and trial8 is 0.8. In the example in FIG. 9, the smallest correlation coefficient among models is 0.77, which is high, and accordingly it is conceivable that there will be no great difference regardless of which model the generation unit 132 selects.

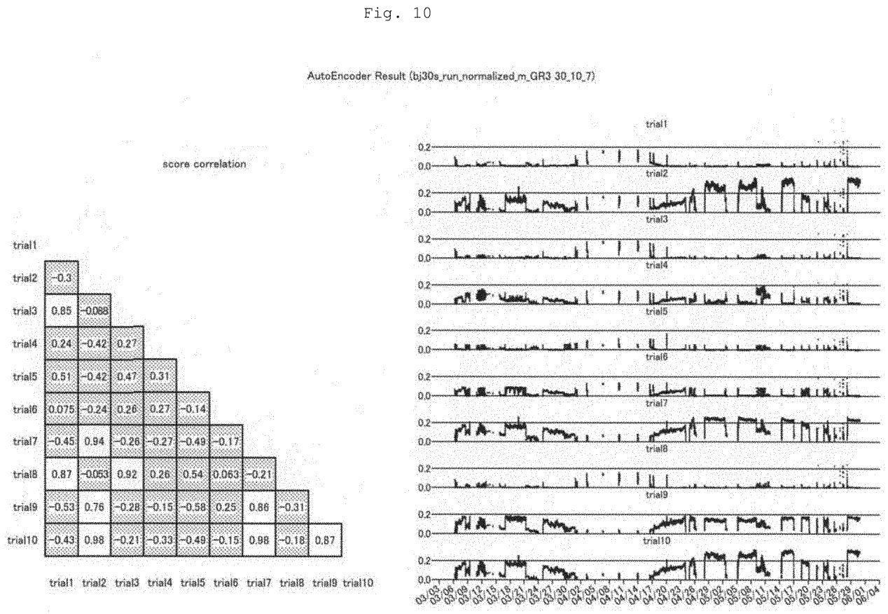

Conversely, FIG. 10 is a diagram illustrating an example of degree of anomaly in a case of models not stabilizing. The numerical values in the rectangles are correlation coefficients among the models, in the same way as in FIG. 9. For example, the correlation coefficient between a model generated in a trial called trial3 and a model generated in a trial called trial8 is 0.92. In the case of FIG. 10, it would be good to change the number of layers, the number of dimensions per layer, and so forth, and perform model generation again, rather than select from these models.

(4. Handling Temporal Change of Data Distribution)

There is data in which distribution changes as time elapses, such as data output from a server system. Accordingly, in a case where a model generated using training data collected before change in distribution is used to perform detection of test data collected after change in distribution, the degree of anomaly of normal data will conceivably be great, since the normal distribution of the test data has not been learned.

Accordingly, the preprocessing unit 131 divides the data for training that is time-series data by a sliding window for predetermined periods. The generation unit 132 then generates models on the basis of each piece of data per sliding window divided by the preprocessing unit 131. The generation unit 132 may also perform both generation of models based on training data of a fixed period (fixed-period learning) and generation of models based on training data of each of periods into which the fixed period has been divided by the sliding window (sliding learning). Also, in sliding learning, instead of using all models generated on the basis of data that has been divided for each sliding window, one can be selected and used therefrom. For example, applying a model created using data backtracking for a predetermined period from the previous day, for anomaly detection for the following one day, may be repeated.

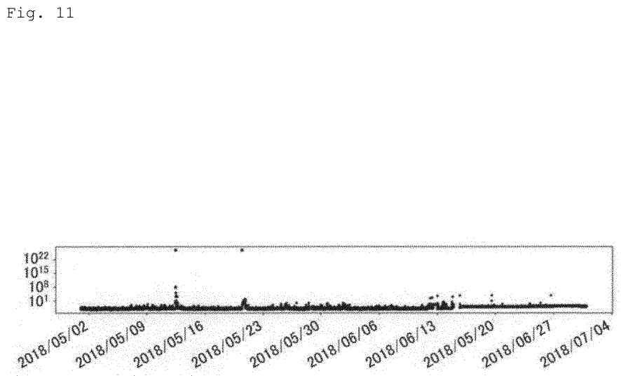

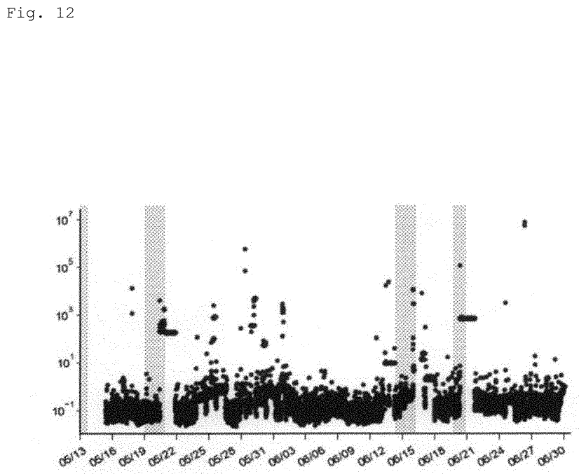

FIG. 11 is a diagram illustrating an example of results of fixed-period learning. FIG. 12 is a diagram illustrating an example of results of sliding learning. FIG. 11 and FIG. 12 represent the degree of anomaly calculated from each model. In the sliding learning, the degree of anomaly of the following one day is calculated by a model created with two weeks' worth of data up to the previous day. The sliding learning has more periods where the degree of anomaly rises, as compared to fixed-period learning. This can be viewed as being due to the frequent change in data distribution as viewed in short term.

(5. Removing Abnormal Data from Training Data)

The detection device 10 performs so-called anomaly detection, and accordingly the training data is preferably normal data as much as possible. Meanwhile, collected training data may sometimes contain abnormal data that is difficult for humans to recognize and data with a high rate of outliers.

The preprocessing unit 131 excludes data having a degree of anomaly that is higher than a predetermined value from data for training. The degree of anomaly is calculated using at least one model included in at least one model group out of a model group generated for each of a plurality of different normalization techniques regarding data for training, and a model group in which model parameters differing from each other are set. Note that the generating of models and the calculating of degree of anomaly in this case may be performed by the generation unit 132 and the detection unit 133, respectively.

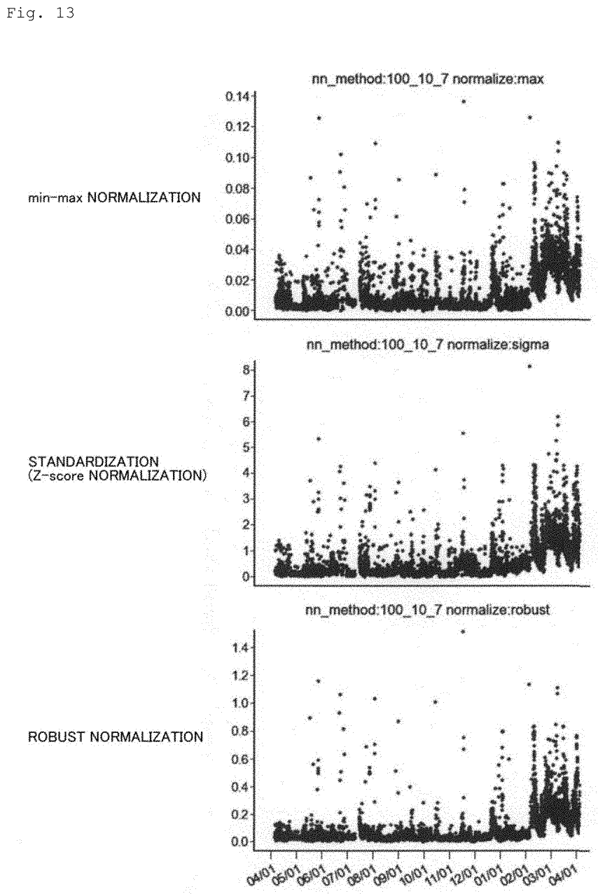

FIG. 13 is a diagram illustrating examples of the degree of anomaly for each normalization technique. As illustrated in FIG. 13, the degree of anomaly on 02/01 and thereafter is high, throughout each of the normalization techniques. In this case, the preprocessing unit 131 excludes data on 02/01 and thereafter from the training data. Also, the preprocessing unit 131 can exclude data in which the degree of anomaly becomes high under at least one normalization technique.

Also, in a case of calculating the degree of anomaly using a model group in which different model parameters are set as well, a plurality of pieces of time-series data of degree of anomaly are obtained, as illustrated in FIG. 13. In this case as well, the preprocessing unit 131 excludes data with a high degree of anomaly in any of the pieces of time-series data.

### Processing of First Embodiment

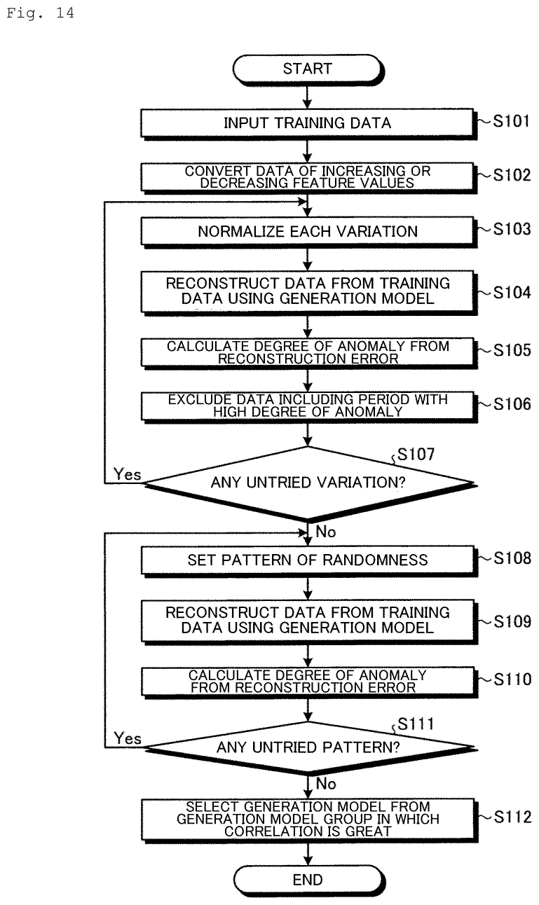

A flow of learning processing at the detection device 10 will be described with reference to FIG. 14. FIG. 14 is a flowchart illustrating the flow of learning processing in the detection device according to the first embodiment. As shown in FIG. 14, first, the detection device 10 accepts input of training data (step S101). Next, the detection device 10 converts data of feature values that increase or decrease (step S102). For example, the detection device 10 converts the data into difference or ratio among predetermined clock times.

Now, the detection device 10 executes normalization on the training data for each variation (step S103). Variations are normalization techniques, including the min-max normalization, standardization (Z-score), and robust normalization, which are illustrated in FIG. 13, and so forth.

The detection device 10 reconstructs data from the training data, using the generation model (step S104). The detection device 10 then calculates the degree of anomaly from the reconstruction error (step S105). The detection device 10 then excludes data of a period in which the degree of anomaly is high (step S106).

Now, in a case where there is an untried variation (step S107, Yes), the detection device 10 returns to step S103, selects the untried variation, and repeats the processing. Conversely, in a case where there is no untried variation (step S107, No), the detection device 10 advances to the next processing.

The detection device 10 sets a pattern of randomness (step S108), and thereupon uses the generation model to reconstruct data from the training data (step S109). The detection device 10 then calculates the degree of anomaly from the reconstruction error (S110).

Now, in a case where there is an untried pattern (step S111, Yes), the detection device 10 returns to step S108, and sets the untried pattern and repeats processing. Conversely, in a case where there is no untried pattern (step S111, No), the detection device 10 advances to the next processing.

The detection device 10 calculates the magnitude of correlation of generation models of the patterns, and selects a generation model from among a model group in which the correlation is great (step S112).

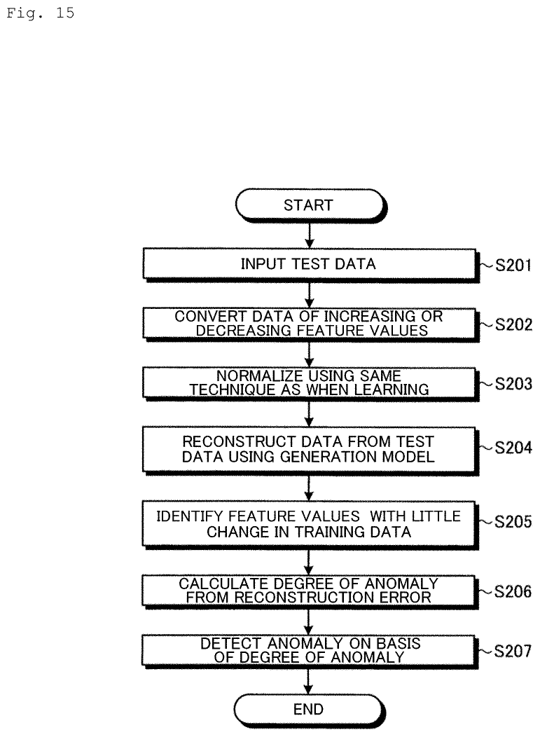

The flow of detection processing of the detection device 10 will be described with reference to FIG. 15. FIG. 15 is a flowchart illustrating the flow of detection processing in the detection device according to the first embodiment. First, the detection device 10 accepts input of test data, as illustrated in FIG. 15 (step S201). Next, the detection device 10 converts data with feature values that increase or decrease (step S202). For example, the detection device 10 converts each piece of data into difference or ratio among predetermined clock times.

The detection device 10 normalizes the test data using the same technique as when learning (step S203). The detection device 10 then reconstructs data from the test data using the generation model (step S204). The detection device 10 here identifies feature values of which there is little change in the training data (step S205). At this time, the detection device 10 may exclude the identified feature values from being objects of calculation of degree of anomaly. The detection device 10 then calculates the degree of anomaly from the reconstruction error (step S206). Further, the detection device 10 detects anomalies on the basis of the degree of anomaly (step S207).

### Advantageous Effects of First Embodiment

The preprocessing unit 131 processes the data for training and the detection object data. Also, the generation unit 132 generates models by deep learning, on the basis of the data for training processed by the preprocessing unit 131. Also, the detection unit 133 inputs the detection object data, processed by the preprocessing unit 131, into the model, calculates the degree of anomaly on the basis of output data obtained, and detects anomalies in the detection object data on the basis of the degree of anomaly. Thus, according to the present embodiment, preprocessing and selection of training data, and model selection can be appropriately performed in a case of performing anomaly detection using deep learning, and detection precision can be improved.

The preprocessing unit 131 identifies feature values in which the degree of magnitude in change as to time is no greater than a predetermined value, out of data for training that is time-series data of feature values. The detection unit 133 also detects anomalies on the basis of at least one of feature values identified by the preprocessing unit 131 and feature values other than the feature values identified by the preprocessing unit 131, out of the feature values of detection object data. Accordingly, the detection device 10 can exclude data that causes the detection precision to deteriorate.

The preprocessing unit 131 converts part or all of the data for training and the detection object data into difference or ratio among predetermined clock times of the data. Accordingly, the detection device 10 can suppress erroneous detection even without completely covering the range that the feature values in the training data can assume. Also, removing the effects of rising or falling trend components can suppress the effects of change in the range of values over time.

The generation unit 132 uses an autoencoder for deep learning. Accordingly, the detection device 10 can perform calculation of degree of anomaly and anomaly detection from the reconstruction error.

The generation unit 132 performs learning of the data for training a plurality of times. Also, the detection unit 133 detects anomalies using a model selected from the models generated by the generation unit 132 in accordance with the strength of mutual relation. Accordingly, the detection device 10 can select an optimal model.

The preprocessing unit 131 divides the data for training, which is time-series data, by sliding windows for each predetermined period. Also, the generation unit 132 generates a model on the basis of each piece of data for each sliding window divided by the preprocessing unit 131. Accordingly, the detection device 10 can generate a model that follows change in data distribution at an early state, and can suppress erroneous detection due to effects of change in data distribution.

The preprocessing unit 131 excludes, from the data for training, data of which the degree of anomaly calculated using at least one model group of a model group generated for each of a plurality of different normalization techniques of data for training, and a model group in which different model parameters are set for each, is higher than a predetermined value. Accordingly, the detection device 10 can exclude data that causes the detection precision to deteriorate.

### Output Example of Detection Device

An output example of detection results by the detection device 10 will be described here. The detection device 10 can perform learning and detection of text logs and numerical value logs, for example. Examples of feature values of numerical logs include values that are numerical values measured by various types of sensors, and numerical values subjected to statistical processing. An example of feature values of text logs is, in an arrangement in which messages are classified and IDs are assigned thereto, values representing the frequency of appearance of IDs at each of certain clock times.

Settings and so forth for obtaining the following output results will be described. First, the data used was numerical logs (approximately 350 metrics) and text logs (approximately 3000 to 4500 IDs) acquired from three controller nodes of an OpenStack system. Also, the data collection period was 5/1 through 6/30, and collection intervals were five minutes. Also, eight abnormal events, including a maintenance day, occurred during the period.

The detection device 10 generated a model for each controller node. The detection device 10 also performed detection using the models. The learning period was 5/1 through 6/5. The evaluation period that was the object for detection was 5/1 through 6/30.

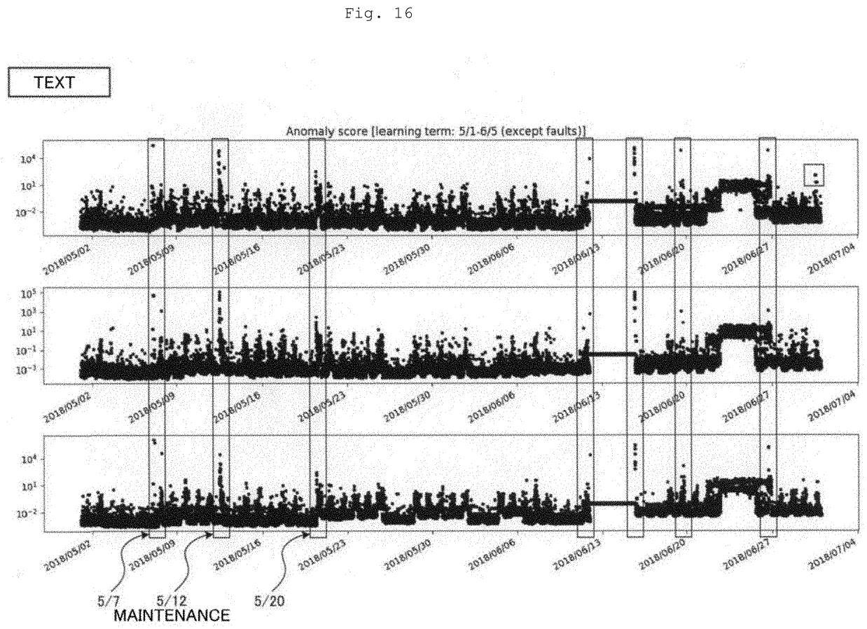

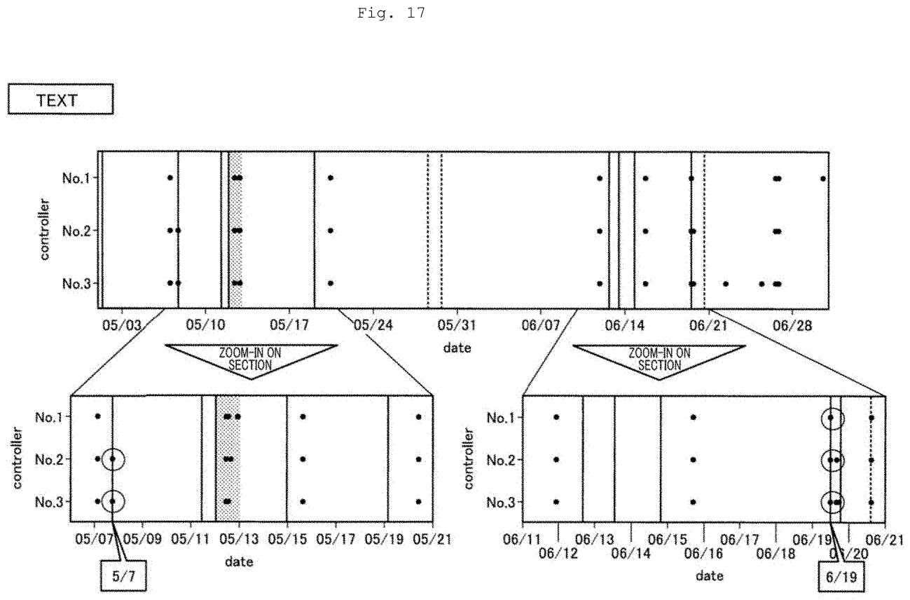

FIG. 16 is a diagram illustrating an example of the degree of anomaly of text logs. The detection device 10 outputs high degrees of anomaly for 5/12 on which maintenance was performed, and for 6/19 on which a failure occurred, as illustrated in FIG. 16. Also, FIG. 17 is a diagram illustrating an example of relation between the degree of anomaly of text logs and failure information. The detection device 10 outputs high degrees of anomaly for 5/7 and 6/19 on which abnormalities occurred, as illustrated in FIG. 17.

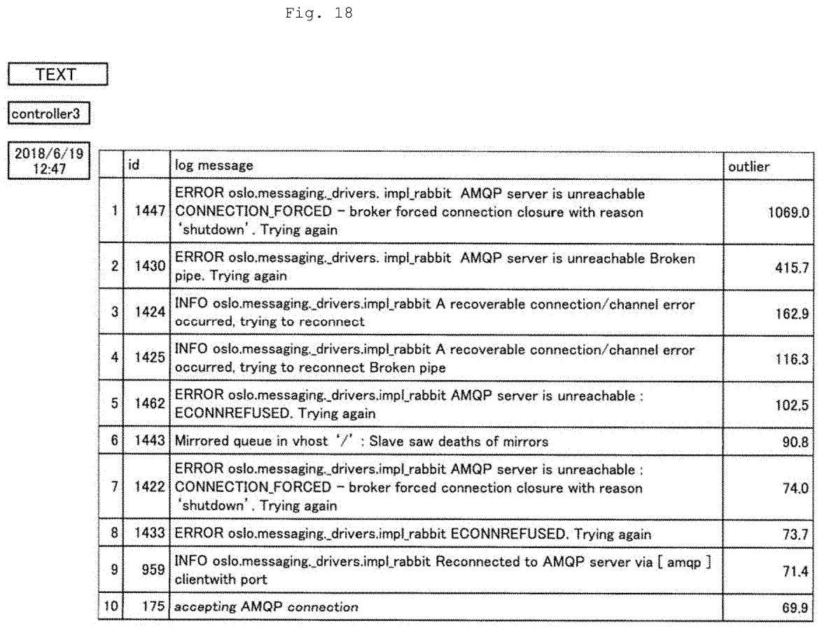

FIG. 18 is a diagram illustrating an example of text logs at the time of failure occurring, and the degree of anomaly of each feature value. Note that outlier represents the degree of anomaly for each feature value, showing ten log messages of which the values were great. Looking at the log messages at the clock time of 6/19 when a rabbit-related failure occurred, many have content relating to rabbit, and ERROR is shown for some, as illustrated in FIG. 18. Thus, estimation can be made that what happened at rabbit is the cause.

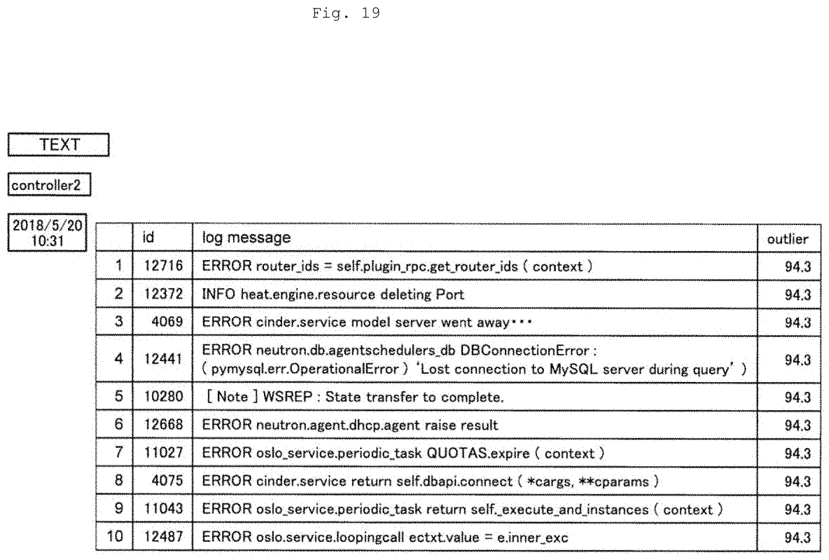

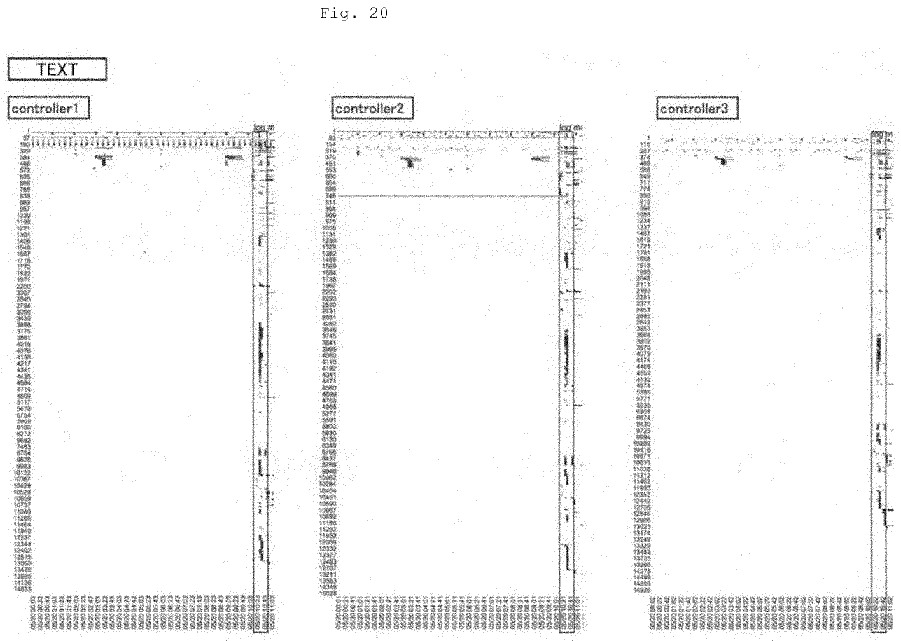

FIG. 19 is a diagram illustrating an example of text logs at the time of the degree of anomaly rising, and the degree of anomaly of each feature. Also, FIG. 20 is a diagram illustrating an example of data distribution of text log IDs at clock times before and after the degree of anomaly rising. As illustrated in FIG. 19, the degrees of anomaly for each feature of the top ten logs agree, and these were the same value in 400 or more logs. Also, as illustrated in FIG. 20, the IDs of text logs occurring at each controller are similar, and it can be seen that these IDs did not appear at all at clock times prior to 10:31. This suggests that an abnormality occurred in which logs that usually do not appear were output in great amounts at 10:31.

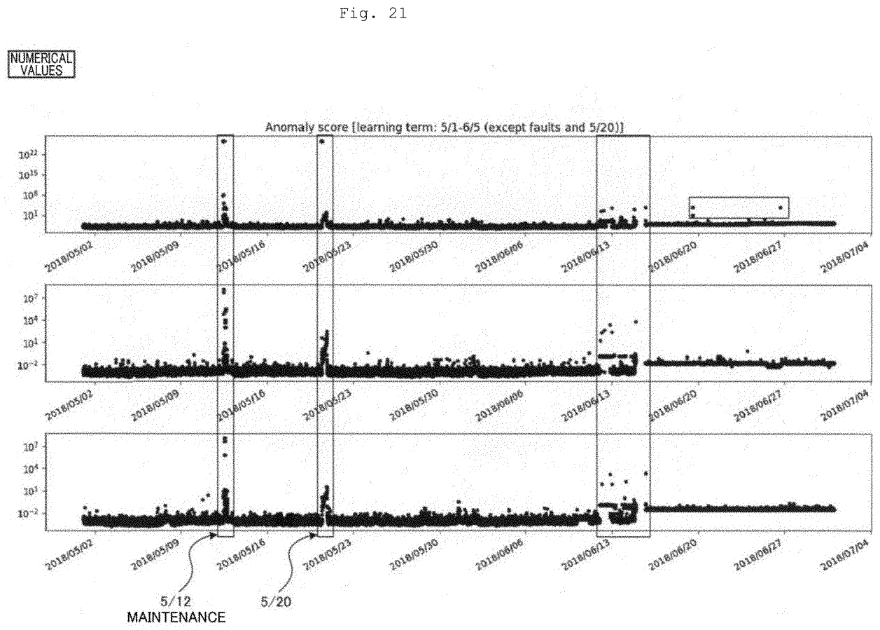

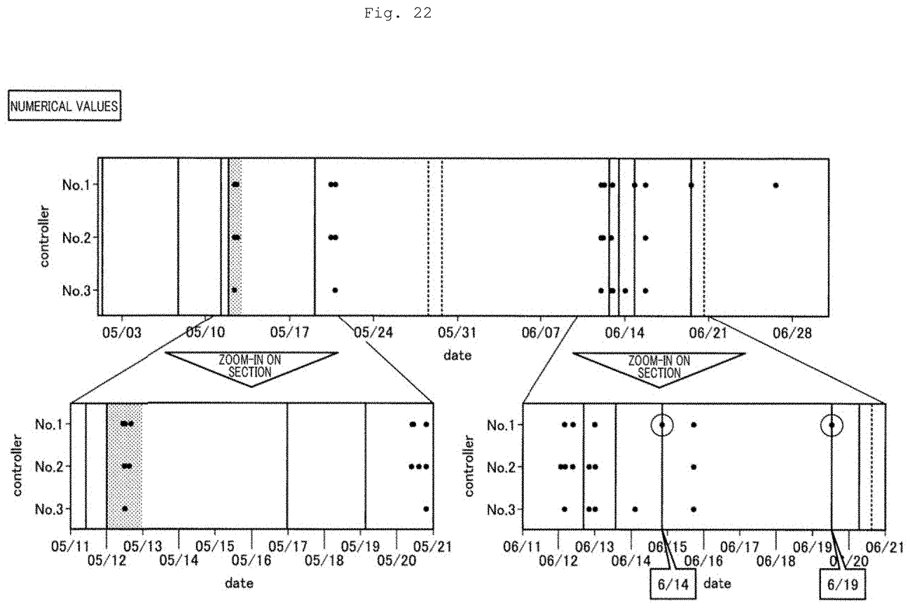

FIG. 21 is a diagram illustrating an example of the degree of anomaly of numerical value logs. As illustrated in FIG. 21, the detection device 10 outputs high degrees of anomaly for 5/12 on which maintenance was performed, and for 5/20 on which a failure occurred. Also, FIG. 22 is a diagram illustrating an example of relation between the degree of anomaly of numerical value logs and failure information. As illustrated in FIG. 22, the detection device 10 outputs high degrees of anomaly for 6/14 and 6/19 on which abnormalities occurred.

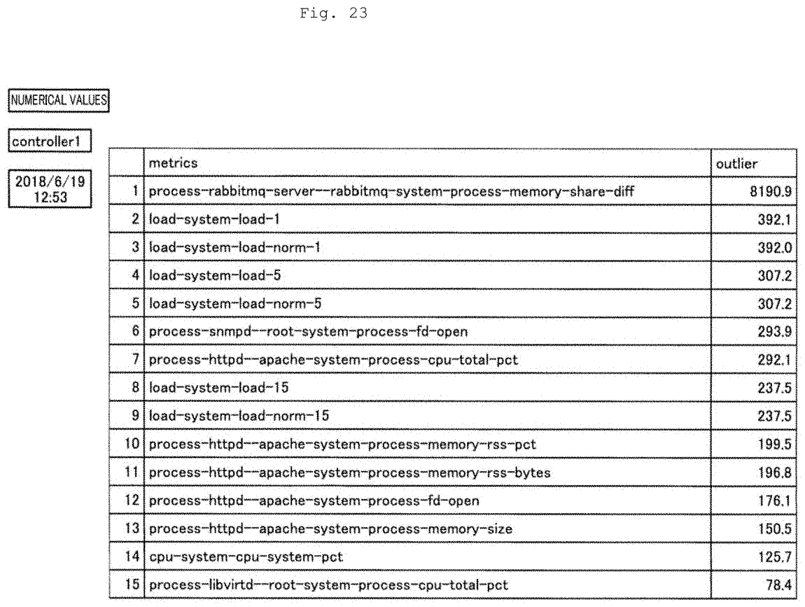

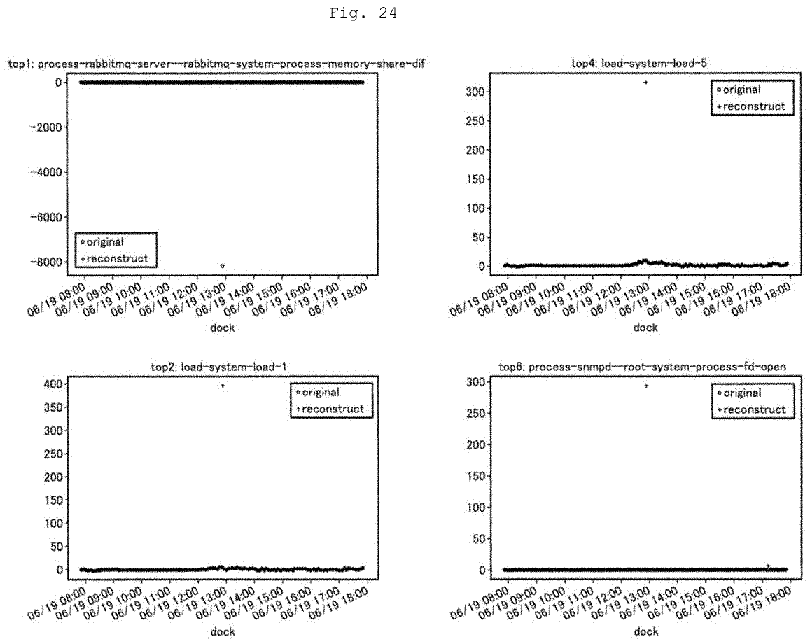

FIG. 23 is a diagram illustrating an example of numerical value logs at the time of failure occurring, and the degree of anomaly of each feature value. As illustrated in FIG. 23, the detection device 10 outputs high degrees of anomaly for the memory-related feature value of rabbit at the same clock time on 6/19 when the rabbit-related failure occurred. FIG. 24 is a diagram illustrating an example of input data and reconstructed data for each feature value of numerical value logs before and after the same clock time on 6/19. Input data is represented by original, and reconstructed data is represented by reconstruct. It can be seen from FIG. 24 that with regard to the memory-related feature value for rabbit in top1 where the degree of anomaly for each feature value was the greatest, input data became a markedly small value at this clock time, but this change could not be reconstructed well. Conversely, confirmation can be made from the remaining three feature values that the reconstructed data at this clock time rose greatly. It is estimated that this is the result of learning that when the memory-related feature value for rabbit falls, the remaining three feature values rise, but the degree of fall was greater than anticipated during the learning period, and accordingly the degrees of anomaly were great.

### Other Embodiments

An embodiment in a case in which the generation unit 132 uses an autoencoder for deep learning has been described so far. However, the generation unit 132 may use a recurrent neural network (hereinafter, RNN) for deep learning. That is to say, the generation unit 132 uses an autoencoder or an RNN for deep learning.

An RNN is a neural network that takes time-series data as input. For example, anomaly detection methods using RNNs include a method of constructing a prediction model, and a method of constructing a sequence-to-sequence autoencoder model. The RNN here is not limited to simple RNNs, and also includes LSTMs and GRUs, which are variations of RNNs.

In the method of constructing a prediction model, the detection device 10 detects anomalies on the basis of error between the values of original data and predicted values, instead of reconstruction error. For example, predicted values are output values of an RNN in a case of inputting time-series data for a predetermined period, and are estimated values of time-series data at a certain clock time. The detection device 10 detects anomalies on the basis of the magnitude of error between data at a certain clock time that is actually collected and predicted values at that clock time. For example, in a case where the magnitude of error exceeds a threshold value, the detection device 10 detects that an anomaly has occurred at that clock time.

The method of constructing a sequence-to-sequence autoencoder model has the point of constructing an autoencoder in common with the first embodiment, but differs with regard to the point that the neural network is an RNN, and the point that the input data and output data (reconstructed data) is time-series data. In this case, the detection device 10 views the reconstruction error of time-series data to be the degree of anomaly, and can detect anomalies.

### System Configuration, etc.

Also, the components of the devices illustrated in the figures are functional concepts, and do not need to be physically configured in the same way as illustrated in the figures. That is to say, specific forms of distribution and integration of the devices are not limited to those illustrated in the figures, and all or part thereof can be configured being functionally or physically distributed or integrated in optional increments, in accordance with various types of loads, usage states, and so forth. Further, all or an optional part of the processing functions carried out at each device may be realized by a CPU and a program analyzed and executed by the CPU, or alternatively may be realized as hardware through wired logic.

Also, of the processes described in the present embodiment, all or part of processes described as being automatically performed can be manually performed. Alternatively, all or part of processes described as being manually performed can be automatically performed by known methods. Moreover, processing procedures, control procedures, specific names, and information including various types of data and parameters, shown in the above document and figures, can be optionally changed unless specifically stated otherwise.

### Program

As one embodiment, the detection device 10 can be implemented by installing a detection program that executes the above-described detection in a desire computer as packaged software or online software. For example, an information processing device can be caused to function as the detection device 10 by causing the information processing device to execute the above detection program. An information processing device as used here includes desktop and laptop personal computers. Additionally, mobile communication terminals such as smartphones, cellular telephones, PHSs (Personal Handyphone System), and so forth, and further, slate terminal and the like, such as PDAs (Personal Digital Assistant) and so forth, are included in the scope of information processing devices.

Also, the detection device 10 can be implemented as a detection server device that has a terminal device used by a user as a client, and provides services regarding the above-described detection to the client. For example, a detection server device is implemented as a server device that provides a detection service in which training data is input and generation models are output. In this case, the detection server device may be implemented as a Web server, or may be implemented as a cloud that provides services regarding the above-described detection by outsourcing.

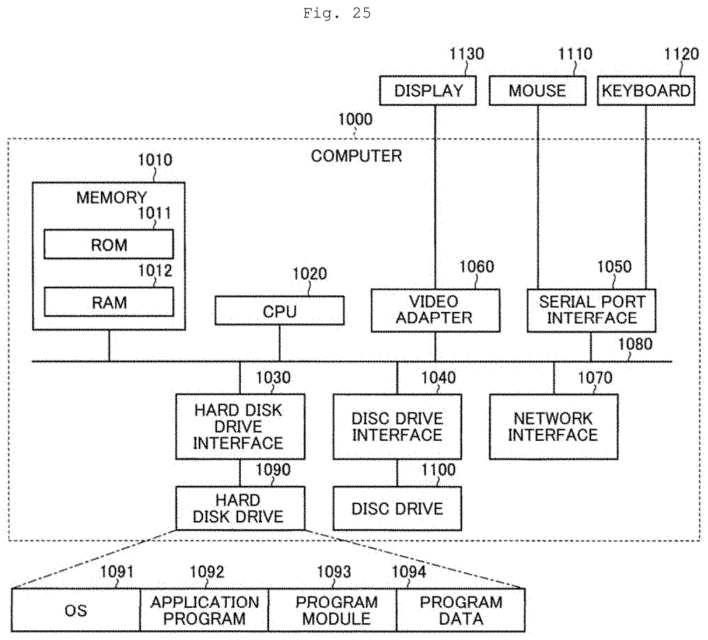

FIG. 25 is a diagram illustrating an example of a computer that executes the detection program. A computer 1000 has memory 1010 and a CPU 1020, for example. The computer 1000 also has a hard disk drive interface 1030, a disc drive interface 1040, a serial port interface 1050, a video adapter 1060, and a network interface 1070. These parts are connected by a bus 1080.

The memory 1010 includes ROM (Read Only Memory) 1011 and RAM 1012. The ROM 1011 stores a boot program such as a BIOS (Basic Input Output System), for example. The hard disk drive interface 1030 is connected to a hard disk drive 1090. The disc drive interface 1040 is connected to a disc drive 1100. A detachable storage medium such as a magnetic disk or an optical disc or the like, for example, is inserted to the disc drive 1100. The serial port interface 1050 is connected to, for example, a mouse 1110 and keyboard 1120. The video adapter 1060 is connected to a display 1130, for example.

The hard disk drive 1090 stores, for example, an OS 1091, an application program 1092, a program module 1093, and program data 1094. That is to say, a program that defines each processing of the detection device 10 is implemented as the program module 1093 in which code that is executable by the computer is described. The program module 1093 is stored in the hard disk drive 1090, for example. The program module 1093 for executing processing the same as the functional configurations of the detection device 10, for example, is stored in the hard disk drive 1090. Note that the hard disk drive 1090 may be substituted by an SSD.

Also, settings data used in processing in the above-described embodiment is stored in the memory 1010 or the hard disk drive 1090, for example, as the program data 1094. The CPU 1020 reads the program module 1093 and the program data 1094 stored in the memory 1010 or the hard disk drive 1090 to the RAM 1012 as necessary, and performs execution of processing of the above-described embodiment.

Note that the program module 1093 and the program data 1094 are not limited to a case of being stored in the hard disk drive 1090, and may be stored in a detachable storage medium for example, and be read out by the CPU 1020 via the disc drive 1100 or the like. Alternatively, the program module 1093 and the program data 1094 may be stored in another computer connected via a network (LAN (Local Area Network), WAN (Wide Area Network), or the like). The program module 1093 and the program data 1094 may then be read out from the other computer by the CPU 1020 via the network interface 1070.

### REFERENCE SIGNS LIST

10 Detection device

11 Input/output unit

12 Storage unit

13 Control unit

121 Model information

131 Preprocessing unit

132 Generation unit

133 Detection unit

1. A detection device, comprising:
preprocessing circuitry that processes data for training and detection object data;
generation circuitry that generates a model by deep learning, on the basis of data for training that is processed by the preprocessing circuitry; and
detection circuitry that calculates a degree of anomaly on the basis of output data obtained by inputting the detection object data that is processed by the preprocessing circuitry into the model, and detecting an anomaly in the detection object data on the basis of the degree of anomaly.

2. The detection device according to claim 1,
wherein the preprocessing circuitry identifies, out of the data for training that is time-series data of feature values, a feature value of which a magnitude in degree of change as to time is no larger than a predetermined value, and
wherein the detection circuitry detects an anomaly on the basis of at least one of a feature value identified by the preprocessing circuitry and a feature value other than a feature value identified by the preprocessing circuitry, out of feature values of the detection object data.

3. The detection device according to claim 1, wherein the preprocessing circuitry converts part or all of the data for training and the detection object data into difference or ratio among predetermined clock times of the data.

4. The detection device according to claim 1, wherein the generation circuitry uses an autoencoder or a recurrent neural network for deep learning.

5. The detection device according to claim 4, wherein the generation circuitry performs learning of the data for training, a plurality of times, and wherein the detection circuitry detects an anomaly using a model selected from models generated by the generation circuitry in accordance with a strength of a mutual relation.

6. The detection device according to claim 4,
wherein the preprocessing circuitry divides the data for training that is time-series data by a sliding window for each predetermined period, and
wherein the generation circuitry generates a model on the basis of each of data for each sliding window, divided by the preprocessing circuitry.

7. The detection device according to claim 4, wherein the preprocessing circuitry excludes, from the data for training, data of which a degree of anomaly calculated using at least one model included in at least one model group of a model group generated for each of a plurality of different normalization techniques of the data for training, and a model group in which different model parameters are set for each, is higher than a predetermined value.

8. A non-transitory computer readable medium including computer instructions for causing a computer to function as the detection device according to claim 1.
